(19) United States
(12) Patent Application Publication
(10) Pub. No.: US 2025/0370563 A1
(43) Pub. Date: Dec. 4, 2025

(54) METHOD FOR TIME SAMPLING ACTIVE-DISCHARGE TOUCH KEY AND APPARATUS FOR THE SAME

(71) Applicant: TONTEK DESIGN TECHNOLOGY LTD., New Taipei City (TW)

(72) Inventors: Yu-Tse LIN, New Taipei City (TW); Yu-Chi CHANG, New Taipei City (TW); Chin-Tsung LIN, New Taipei City (TW); Ting-Hsiu YEH, New Taipei City (TW); Yao-Jen KUO, New Taipei City (TW)

(21) Appl. No.: 18/732,021

(22) Filed: Jun. 3, 2024

(51) Int. Cl. G06F 3/041; G06F 3/044

(52) U.S. Cl. CPC G06F 3/04166; G06F 3/044

(57) ABSTRACT

A time sampling method for active-discharge touch key and the apparatus for the same includes a voltage source, at least one current source, and a sampling circuit. The sampling method first applies a current originating from the touch key to adjust the discharge current value of the current source, an equivalent capacitance of the touch key is discharged with a constant current. The sampling circuit calculates the time change of equivalent capacitance discharged with constant current. When the discharge time exceeds the first discharge cut-off timepoint, the method identifies touch event, namely, the touch key is touched by finger to enhance the accuracy of the time sampling of the touch key. The sensitivity of finger touch is not affected by the parasitic capacitance generated by the touch key in application environment, and not affected by the leakage or residual charge of the parasitic capacitance of the touch key.

### BACKGROUND

### Technical Field

The present invention relates to a time sampling method for active-discharge touch key and the apparatus for the same, especially to time sampling method for active-discharge touch key and the apparatus for the same using adjustable constant current.

### Description of Prior Art

The touch key has different function and architecture with the touch screen, where the touch key functions to sense whether a user finer exerts a touch and the touch screen further identifies touch position besides sensing touch event. Both the touch key and the touch screen have similar working principle based on the time of capacitor discharge current Ic and the charge-discharge time constant T of the capacitor. FIG. 1 shows the graph of voltage (Vc) and current (Ic) for the equivalent capacitor in charging and discharging process during sensing touch event, where τ=R_{D}×C is the time constant, Rd is the resistance value and C is the capacitance value. Besides, in FIG. 1, voltage (Vc) is depicted in solid line while current (Ic) is depicted in dotted line.

Please refer to FIGS. 2 and 3, where FIG. 2 shows the equivalent circuit diagram of a prior art touch key with passive discharge scheme, and FIG. 3 shows the current waveform diagram of the passive discharge. In those figures, Icp denotes the capacitor discharge current for passive discharge and it approaches to 0 at timepoint 5τ. The prior art touch key with passive discharge scheme generally adopts multiple charges and discharges for the touch key to accumulate the change amount of the equivalent capacitance (ψ_{C}) and enhance the sampling accuracy for the time sampling in the touch key because the capacitance variation of the touch key is only several pF. Based on the discharge formula of the capacitor, the remaining charge need infinite (∞) time to completely exhaust. In practical situation, the discharge time cannot reach infinite, there is still residual charge remaining, which will affect the accuracy of time sampling.

Taiwan invention 1677196 separates the sampling signal into several charge-and-discharge triangle waves. However, this prior art adopts charge transfer technology such that residual charge still remains. As a result, the load (equivalent capacitor) of touch key and the parasite capacitor of touch key are limited and the parasite capacitor has leakage problem. Taiwan invention U.S. Pat. No. 1,465,999 also discloses sampling signal with several charge-and-discharge square waves to enhance the accuracy of time sampling for touch key.

### SUMMARY

In view of the disadvantages of prior art touch key with passive discharge scheme, the inventor of this application had intense research to develop a time sampling method for active-discharge touch key and architecture for the same. The accuracy of time sampling for the touch key can be enhanced while the touch sensing sensitivity of user finger is not affected by parasitic capacitance caused by application environment of the touch key and is also not affected by the bypass leakage of parasitic capacitance in touch key and residual charge.

To achieve above object, according to one of the technique features of the present invention, the present invention provides a time sampling method for active-discharge touch key, the method being applied to at least touch key and comprising: applying a current source to the touch key; adjusting a discharging current value of the current source such that an equivalent capacitance of the touch key is discharged with a constant current; and calculating a temporal change of the equivalent capacitance discharged by the constant current and identifying that the touch key is touched by user finger when a discharge cutoff time exceeds a first discharge cutoff timepoint.

To achieve above object, according to another one of the technique features of the present invention, the present invention provides a time sampling apparatus for active-discharge touch key, the apparatus being applied to at least touch key and comprising: a voltage source connected in series with at least one charging switch and at least one discharging switch, the touch key being connected between the at least one charging switch and the at least one discharging switch; at least one current source connected in series with the at least one discharging switch and discharging an equivalent capacitance of the touch key with a constant current; and a sampling circuit connected to the touch key to calculate a temporal change of the equivalent capacitance discharged with constant current, wherein the time sampling apparatus identifies that the touch key is touched by user finger when a discharge cutoff time exceeds a first discharge cutoff timepoint.

To achieve above object, according to still another one of the technique features of the present invention, the present invention provides an n integrated circuit providing time sampling for active-discharge touch key, comprising: a plurality of touch keys connected to a touch key signal bus; a charging circuit connected to the touch key signal bus and charging equivalent capacitances of the touch keys; an active discharging circuit connected to the touch key signal bus and discharging the equivalent capacitances of the touch keys with constant current; a sampling circuit connected to the touch key signal bus and calculating a temporal change of the equivalent capacitances of the touch keys when the equivalent capacitances are discharged by the constant current, wherein the integrated circuit identifies that one of the touch keys is touched by user finger when a discharge cutoff time of the equivalent capacitance in the touch key exceeds a first discharge cutoff timepoint.

### BRIEF DESCRIPTION OF THE DRAWINGS

FIG. 1 shows the graph of voltage and current for the equivalent capacitor in charging and discharging process during sensing touch event in prior art.

FIG. 2 shows the equivalent circuit diagram of a prior art touch key with passive discharge scheme.

FIG. 3 shows the current waveform diagram of the prior art touch key with passive discharge scheme.

FIG. 4 is a circuit block schematic diagram for time sampling in the active-discharge touch key of the present invention.

FIG. 5 is a time sampling waveform diagram of the detection circuit of active discharge scheme of the present invention.

FIG. 6 is a sampling waveform timing diagram of touch key according to the present invention.

FIG. 7 shows the circuit block diagram for the active-charge scheme according to another embodiment of the present invention.

FIG. 8 is a time sampling waveform diagram for the active-charge scheme according to the present invention.

FIG. 9 shows the schematic block diagram of an integrated circuit for time sampling of an active-discharge touch key according to the present invention.

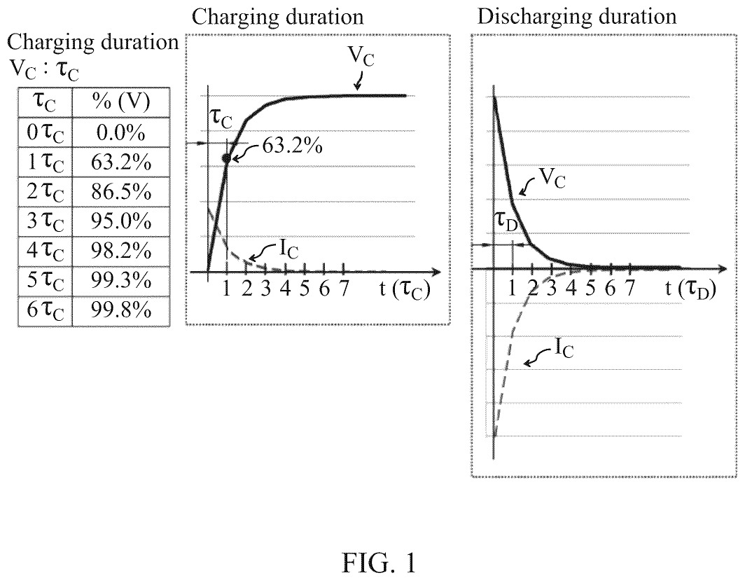

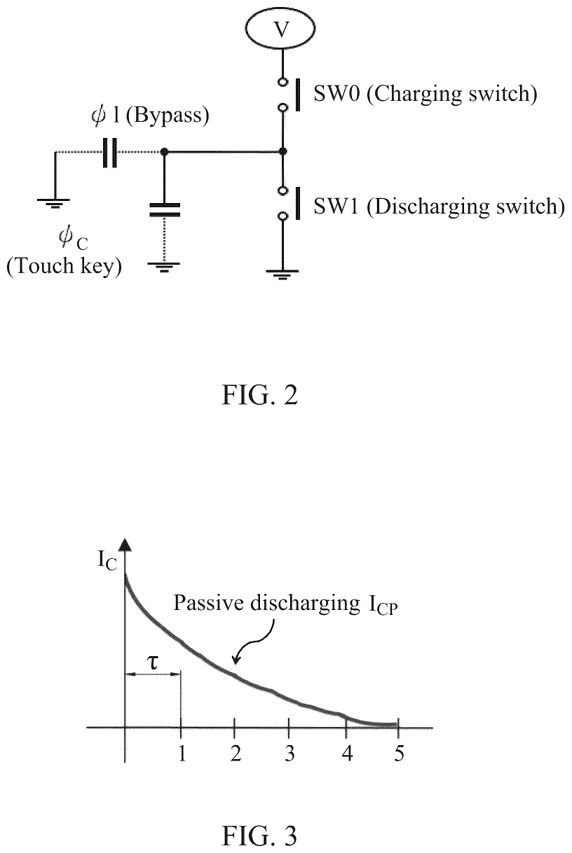

### DETAILED DESCRIPTION

The technical contents of the present invention will become apparent with the detailed description of embodiments and the accompanied drawings as follows. However, it shall be noted that the accompanied drawings are for illustrative purposes only such that they shall not be used to restrict the scope of the present invention.

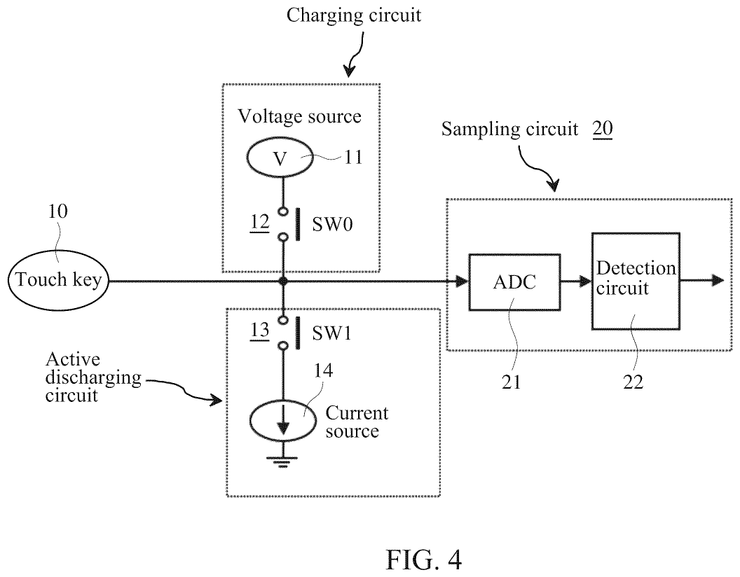

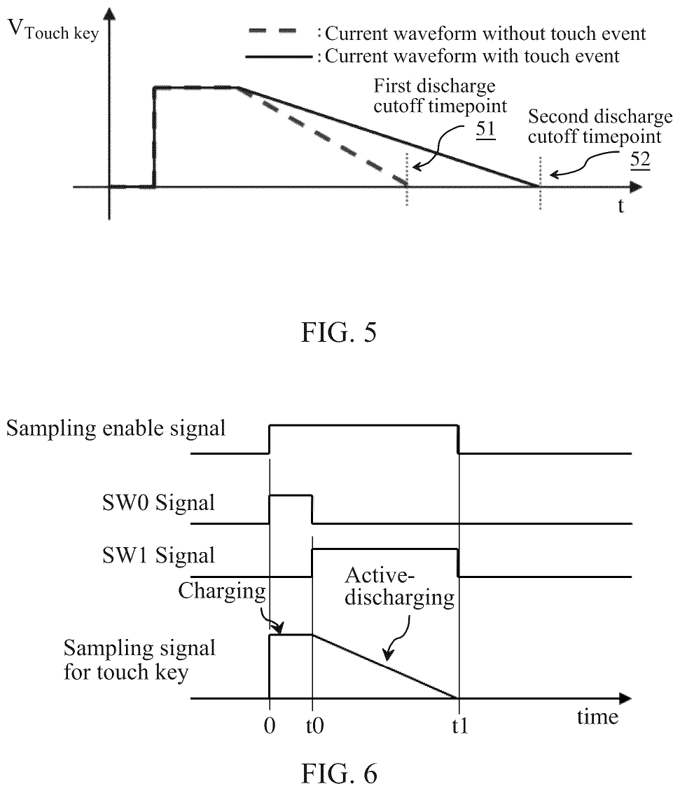

Please refer to FIG. 4 and FIG. 5, where FIG. 4 is a circuit block schematic diagram for time sampling in the active-discharge touch key of the present invention, and FIG. 5 is a time sampling waveform diagram of the detection circuit of active discharge scheme of the present invention. The present invention mainly uses an active-discharge touch key 10 and the present invention provides a circuit apparatus for sampling charge and discharge time of equivalent capacitance ψ_{C} in a touch key 10. The apparatus includes a voltage source 11 in serial connection between a charging switch (SW0) 12 and a discharging switch (SW1) 13. The apparatus further includes a current source 14 and a sampling circuit 20, where the touch key 10 is connected between the charging switch (SW0) 12 and the discharging switch (SW1) 13. The current source 14 is connected between the discharging switch (SW1) 13 and a ground end. When the current source 14 is applied to the touch key 10, the equivalent capacitance (ψC) of the touch key 10 can be discharged with a constant current by adjusting the discharge current value of the current source 14.

The sampling circuit 20 is connected to the touch key 10 and a connection point between the charging switch (SW0) 12 and the discharging switch (SW1) 13, and is used to calculate the temporal voltage or current changes of the equivalent capacitance (ψ_{C}) of the touch key 10 with constant current discharge. When the charging switch (SW0) 12 is turned on (ON) and the discharging switch (SW1) 13 is turned off (OFF), the voltage source (V) 11 charges the equivalent capacitance (ψ_{C}) of the touch key 10 to the voltage source (V) 11 until the voltage reaches the voltage source (V) 11. Afterward, the charging switch (SW0) 12 is turned off (OFF) and the discharging switch (SW1) 13 is turned on (ON), and the equivalent capacitance (ψC) of the touch key 10 is discharged with constant current until the discharge cutoff time exceeds a first discharge cutoff timepoint 51. It means that the touch key 10 is touched by user finger. The legend “first discharge cutoff timepoint 51” in FIG. 5 denotes a discharge cutoff timepoint when the touch key 10 is not touched by user finger.

Please refer also to FIGS. 4, 5, and 6, where FIG. 6 is a sampling waveform timing diagram of touch key according to the present invention. By adjusting the constant current value of the current source 14, the discharge current value (I_{CA}) of the equivalent capacitance (ψC) of the touch key 10 can be adjusted. The discharge time of the equivalent capacitance (ψC) of the touch key 10, namely, the discharge cutoff timepoint 51, can be increased to enhance the accuracy of time sampling of the touch key 10.

As can be seen from FIG. 6, before time sampling the equivalent capacitance (ψC) of the touch key 10 in discharge period, the equivalent capacitance (ψC) needs to be charged. The charge period is 0˜t0 and the discharge period is t0˜t1, while the sampling enable period of the touch key 10 is 0˜t1. As can be seen in FIG. 5, the time sampling of the equivalent capacitance (C) of the touch key 10 during discharge period is relevant only to the current value (I_{CA}). Therefore, the residue charge of the touch key 10 will not influence the accuracy in time sampling. Besides, the discharge time of the equivalent capacitance (ψ_{C}) of the touch key 10 is proportional to the equivalent capacitance value (ψ_{C}). In above description, to is the discharge start time for the equivalent capacitance of the touch key, and t1 is the discharge cutoff time for the equivalent capacitance of the touch key.

As shown in FIG. 5, the first discharge cutoff timepoint 51 is the discharge cutoff time when the touch key 10 is not touched by user finger, and the second discharge cutoff timepoint 52 is the discharge cutoff time when the touch key 10 is touched by user finger. When the touch key 10 is touched by user finger, the equivalent capacitance value (ω_{C}) of the touch key 10 becomes larger. The dotted line in FIG. 5 is the voltage waveform when the touch key 10 is not touched, and the solid line is the voltage waveform when the touch key 10 is touched.

As shown in FIG. 4, the sampling circuit 20 further includes an analog-to-digital converter (ADC) 21 and a detection circuit 22. The analog-to-digital converter 21 is connected to the touch key 10 for converting the charge and discharge current of the equivalent capacitance (ψ_{C}) into a digital signal, and the detection circuit 22 is connected to the analog-to-digital converter 21 to calculate the temporal discharge change of the equivalent capacitance (ψ_{C}) of the touch key 10.

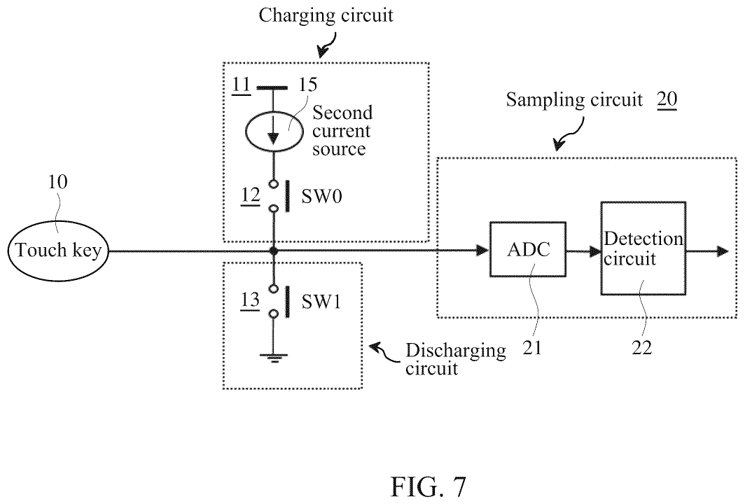

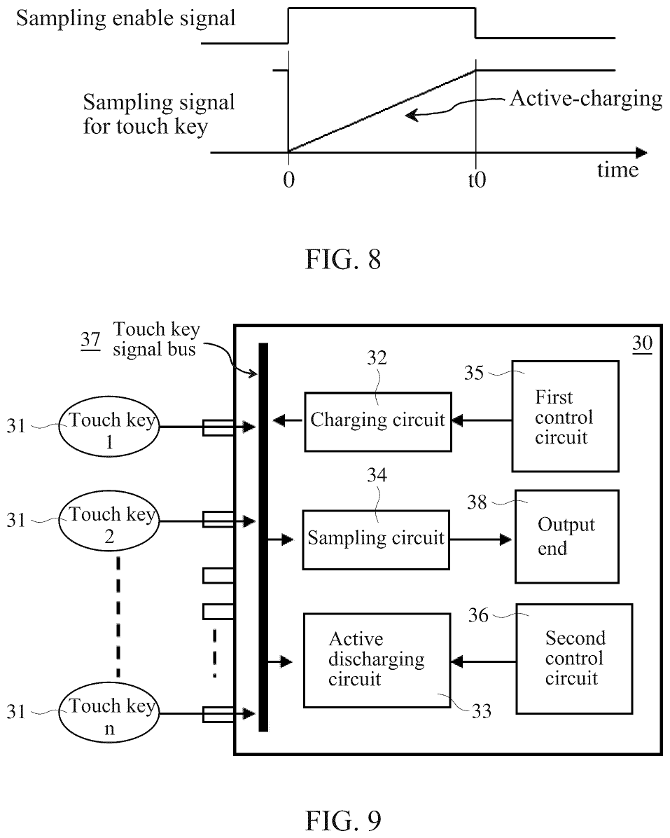

Please refer to FIG. 7 and FIG. 8 for the active-charge scheme according to another embodiment of the present invention, where FIG. 7 shows the circuit block diagram for the active-charge scheme according to another embodiment of the present invention and FIG. 8 shows a time sampling waveform diagram for the active-discharge scheme according to the present invention. The active-charge scheme according to the present invention further includes a second current source 15 serially connected between the voltage source (V) 11 and the charging switch (SW0) 12. When the charging switch (SW0) 12 is turned on (ON) and the discharging switch (SW1) 13 is turned off (OFF), the equivalent capacitance (C) of the touch key 10 can be charged with a constant current. As can be seen from the waveform diagram in FIG. 8, the charge period 0˜t0 for the equivalent capacitance (ψC) of the touch key 10 can be prolonged to proportional and steady increment until it reaches voltage source (V) when the second current source 15 provides constant charging current to the equivalent capacitance (ψ_{C}) of the touch key 10. The active-discharge process is the same as mentioned above such that the sampling time for the touch key 10 can be prolonged to enhance accuracy of time sampling.

Please also refer to FIG. 9, FIG. 9 shows the schematic block diagram of an integrated circuit for time sampling of an active-discharge touch key according to the present invention. The time sampling architecture for active-discharge touch key of the present invention can be implemented as an integrated circuit 30 architecture, and can be used in applications such as multiple touch key circuits, LED light bars, or mirror touch keys. The integrated circuit 30 includes a plurality of touch keys 31, a charging circuit 32, an active discharging circuit 33, a sampling circuit 34, a first control circuit 35 and a second control circuit 36. More particularly, these touch keys 31 (such as touch key 1, touch key 2 . . . touch key n) are connected to a touch key signal bus 37. The touch key signal bus 37 is connected to the charging circuit 32, the active discharging circuit 33 and the sampling circuit. 34. The first control circuit 35 is connected to the charging circuit 32 for controlling the charging circuit 32 to charge the equivalent capacitance of the touch keys 31.

The second control circuit 36 is connected to the active discharging circuit 33 to control the active discharge circuit 33 to discharge the equivalent capacitance of the touch keys 31 with a constant current. the sampling circuit 34 is used to calculate the temporal change of the equivalent capacitance of the key 31 when it is discharged with a constant current. When the equivalent capacitance discharge cutoff time of any touch key 31 exceeds a first discharge cutoff timepoint, it means that the touch key is touched by a finger. Finally, the sampling circuit 34 sends its detected time sampling for the touch key to an output end 38 for sending to an application apparatus.

In summary, time sampling method for the active-discharge touch key and its apparatus of the present invention extend the time sampling of the touch key with active constant current discharge to enhance accuracy, which is different from the conventional method of charging and discharging the touch key multiple times. The present invention solves the problem of residual charge caused by multiple charges and discharges, and also solves the problem of touch key parasitic capacitance and bypass parasitic capacitance leakage due to constant discharge.

What is claimed is:

1. A time sampling method for active-discharge touch key, the method being applied to at least touch key and comprising:
applying a current source to the touch key;
adjusting a discharging current value of the current source such that an equivalent capacitance of the touch key is discharged with a constant current; and
calculating a temporal change of the equivalent capacitance discharged by the constant current and identifying that the touch key is touched by user finger when a discharge cutoff time exceeds a first discharge cutoff timepoint.

2. The time sampling method in claim 1, wherein in the step of calculating a temporal change of the equivalent capacitance discharged by the constant current, the method identifies that the touch key is not touched by the user finger when the discharge cutoff time does not exceed the first discharge cutoff timepoint.

3. The time sampling method in claim 2, wherein in the step of adjusting the discharge current value of the current source, a discharge time of the equivalent capacitance of the touch key exceeds the first discharge cutoff timepoint, and the discharge time is proportional to equivalent capacitance value.

4. The time sampling method in claim 3, wherein the first discharge cutoff timepoint is the discharge cutoff time when the touch key is not touched by user finger, and further comprising a second discharge cutoff timepoint being discharge cutoff time when the touch key is touched by user finger.

5. The time sampling method in claim 4, further comprising, before the step of calculating a temporal change of the equivalent capacitance discharged by the constant current,
charging and discharging the equivalent capacitance of the touch key, wherein a charge period is 0˜t0, a discharge period is t0˜t1 and a sampling enable period of the touch key is 0˜t1;
wherein t0 is discharge start time for the equivalent capacitance of the touch key, and t1 is discharge cutoff time for the equivalent capacitance of the touch key.

6. A time sampling apparatus for active-discharge touch key, the apparatus being applied to at least touch key and comprising:
a voltage source connected in series with at least one charging switch and at least one discharging switch, the touch key being connected between the at least one charging switch and the at least one discharging switch;
at least one current source connected in series with the at least one discharging switch and discharging an equivalent capacitance of the touch key with a constant current; and
a sampling circuit connected to the touch key to calculate a temporal change of the equivalent capacitance discharged with constant current, wherein the time sampling apparatus identifies that the touch key is touched by user finger when a discharge cutoff time exceeds a first discharge cutoff timepoint.

7. The time sampling apparatus in claim 6, wherein the sampling circuit comprises
an analog-to-digital converter (ADC) connected to the touch key for converting a charge and discharge current of the equivalent capacitance into a digital signal; and
a detection circuit connected to the analog-to-digital converter to calculate a temporal change of the equivalent capacitance of the touch key when the equivalent capacitance is discharged.

8. The time sampling apparatus in claim 6, wherein when the charging switch is turned on and the discharging switch is turned off, the voltage source charges the equivalent capacitance of the touch key, wherein when the charging switch is turned off and the discharging switch is turned on, the equivalent capacitance of the touch key is discharged with constant current.

9. The time sampling apparatus in claim 6, wherein the time sampling apparatus is applied in multiple touch key circuits, LED light bars, or mirror touch keys.

10. The time sampling apparatus in claim 6, further comprising a second current source serially connected between the voltage source and the at least one charging switch, and the second current source charging the equivalent capacitance of the touch key with constant current.

11. An integrated circuit providing time sampling for active-discharge touch key, comprising:
a plurality of touch keys connected to a touch key signal bus;
a charging circuit connected to the touch key signal bus and charging equivalent capacitances of the touch keys;
an active discharging circuit connected to the touch key signal bus and discharging the equivalent capacitances of the touch keys with constant current;
a sampling circuit connected to the touch key signal bus and calculating a temporal change of the equivalent capacitances of the touch keys when the equivalent capacitances are discharged by the constant current, wherein the integrated circuit identifies that one of the touch keys is touched by user finger when a discharge cutoff time of the equivalent capacitance in the touch key exceeds a first discharge cutoff timepoint.

12. The integrated circuit in claim 11, further comprising:
a first control circuit connected to the charging circuit for controlling the charging circuit to charge the equivalent capacitances of the touch keys; and
a second control circuit connected to the active discharging circuit to control the active discharge circuit to discharge the equivalent capacitances of the touch keys with constant current.
